(19) United States
(12) Patent Application Publication
(10) Pub. No.: US 2017/0311720 A1
(43) Pub. Date: Nov. 2, 2017

(54) Wall-Hanging Storage System

(71) Applicant: Anthony Vincent Centrella, Cold Spring Harbor, NY (US)

(72) Inventor: Anthony Vincent Centrella, Cold Spring Harbor, NY (US)

(21) Appl. No.: 15/141,811

(22) Filed: Apr. 28, 2016

(51) Int. Cl. A47B 96/06; F16B 45/00; A47B 55/00; A47B 96/02; F16M 13/02

(52) U.S. Cl. CPC A47B 96/067; F16M 13/027; F16M 13/02; A47B 55/00; A47B 96/02; F16B 45/00

(57) ABSTRACT

An improved wall-hanging storage system without some of the disadvantages of the prior art is disclosed. Advances in materials science, chemistry, and engineering allow for the utilization of less-expensive, but strong molded pieces that are weight bearing. These new materials allow for new shapes and systems.

### FIELD OF THE INVENTION

The present invention relates to systems for storage in general, and, more particularly, to wall-hanging storage systems.

### BACKGROUND OF THE INVENTION

Organization of items of varying sizes, masses/weights, and importance, is a multi-billion dollar industry, with countless systems each promising to organize one's belongings and even one's life.

There are systems that utilize expensive components that attach to the walls of interior closets, sheds, and garages, and freestanding systems. Manufacturers and brands of these kinds of systems include Sears/Craftsman, Rubbermaid, Elfa, Ikea, etc.

One commonality between all these systems is cost. These systems typically use metal components, which have to be screwed, soldered, or welded together, and wood, which is expensive, heavy, and potentially harmful to the environment. This makes for considerable expense for the manufacturers and consumers.

Additionally as these products break, they frequently break along the points of failure created by the attachment of the different components. Specifically, the screw, solder, or weld points serve as these points of failure.

There exists a need for improved wall-hanging systems.

### SUMMARY OF THE INVENTION

The present invention is an improved wall-hanging storage system without some of the disadvantages of the prior art. This provides superior storage for a user.

For the purpose of this specification, the term “storage” is defined as any item or system that can hold other items and includes, but is not limited to: wall-hanging systems, closet-organization systems, garage systems, etc.

Advances in materials science, chemistry, and engineering allow for the utilization of less-expensive, but strong molded pieces that are weight bearing. These new materials allow for new shapes and systems, without some of the disadvantages of the prior art.

For example, and without limitation, new plastics and resins allow for the molding of shapes with strengths equal to or greater than many of the systems that utilize older technology. Additionally, these materials may be less expensive than those currently in use, which allows for lower cost to manufacturers and consumers than the systems in the prior art. Furthermore, the use of these materials may have less flex than those materials currently in use.

In utilizing these new materials and processes, points of failure are also eliminated as components may be molded in fewer pieces. One advantage is that these new single-molded pieces have strength and longevity not found in the prior art.

In accordance with the illustrative embodiment of the present invention, system 100 is a wall-hanging storage system. System 100 comprises improved brackets and a rail that provide for stability and storage.

It will also be clear to one skilled in the art, after reading this disclosure, how to make and use alternative embodiments of the present invention in which the system is fashioned in a different manner.

### BRIEF DESCRIPTION OF THE DRAWINGS

FIG. 1 depicts system 100 in accordance with the illustrative embodiment of the present invention.

FIG. 2 depicts bracket 101-a in accordance with the illustrative embodiment of the present invention.

FIG. 3 depicts bracket 101-a in accordance with the illustrative embodiment of the present invention.

FIG. 4 depicts bracket 101-a in accordance with the illustrative embodiment of the present invention.

FIG. 5 depicts bracket 101-a in accordance with the illustrative embodiment of the present invention.

FIG. 6 depicts bracket 101-a in accordance with the illustrative embodiment of the present invention.

FIG. 7 depicts bracket 101-a in accordance with the illustrative embodiment of the present invention.

FIG. 8 depicts bracket 101-a in accordance with the illustrative embodiment of the present invention.

FIG. 9 depicts system 100 in accordance with the illustrative embodiment of the present invention.

FIG. 10 depicts system 100 in accordance with the illustrative embodiment of the present invention.

FIG. 11 depicts system 100 in accordance with the illustrative embodiment of the present invention.

FIG. 12 is depicts system 100 in accordance with the illustrative embodiment of the present invention.

### DETAILED DESCRIPTION

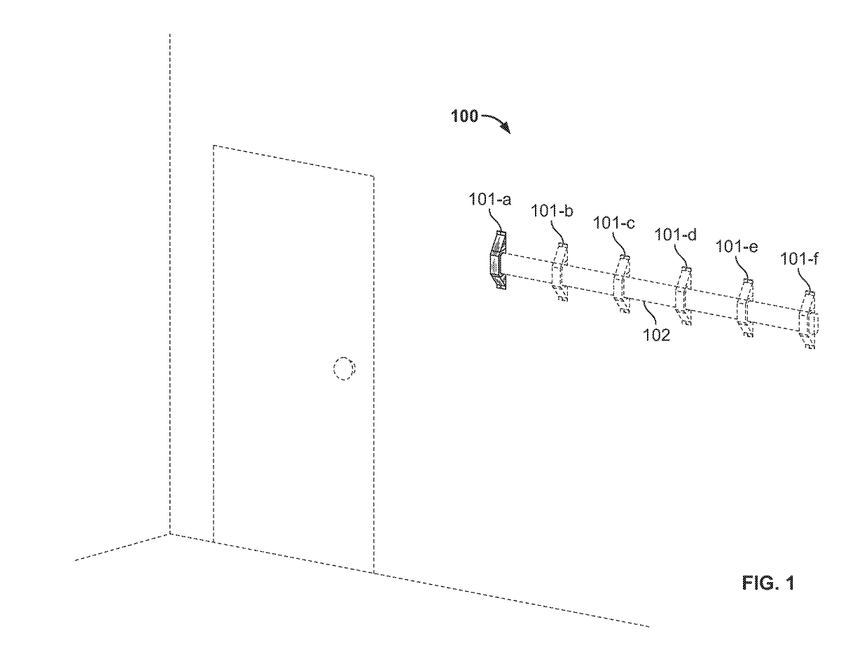

FIG. 1 depicts system 100 in accordance with the illustrative embodiment of the present invention.

System 100 is comprised of brackets 101-a through 101-f and rail 102.

Although system 100 consists of six (6) brackets, it will be clear to one skilled in the art, after reading this disclosure, how to make and use alternative embodiments of the present invention in which there are any number of brackets.

Although system 100 consists of one (1) rail, it will be clear to one skilled in the art, after reading this disclosure, how to make and use alternative embodiments of the present invention in which there are any number of rails.

Although system 100 is depicted of being on the wall of a room, specifically that of a garage, it will be clear to one skilled in the art, after reading this disclosure, how to make and use alternative embodiments of the present invention in which system 100 is placed in any other room, a closet, etc.

Although system 100 is depicted of being on the wall of a room, it will be clear to one skilled in the art, after reading this disclosure, how to make and use alternative embodiments of the present invention in which system 100 is placed upon another surface, for example, and without limitation: a ceiling, an angled beam (or series of beams), a freestanding platform or posts, etc.

In accordance with the illustrative embodiment of the present invention, rail 102 is formed from a single molding.

Although, in accordance with the illustrative embodiment of the present invention, rail 102 is comprised of plastic, it will be clear to one skilled in the art, after reading this disclosure, how to make and use alternative embodiments of the present invention in which any material is used, for example, and without limitation: metal, a different plastic, resin, wood, a combination alloy, acrylic, glass, polymer, polyester or copolyester, or some other high-strength material.

For the purpose of this specification, the term “high-strength material” is defined as any material that has the necessary properties to hold up some quantity of weight that would be useful to a user and that can be shaped into a desirable shape, apparatus, or system. Examples of high-strength materials include, but are not limited to those materials listed above. To reiterate: metal (e.g. steel, aluminum, titanium), plastic, resin, wood, a combination alloy, acrylic, glass, polymer, polyester or copolyester, etc.

One advantage of rail 102 over that of the prior art may be that an end user may be able to cut this down using tools that he or she may have at home and not require specialized tools that are difficult or expensive to obtain or maintain, for example, and without limitation: a hand saw, a table saw, etc. Another advantage may be that this form of molding may be at lower cost, with easier scaling than that of other forms of manufacture.

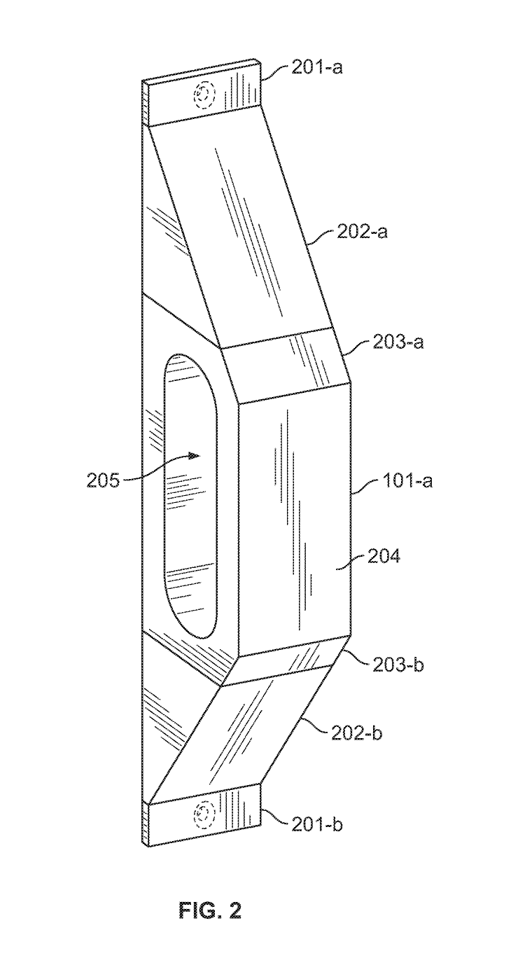

Brackets 101-a through 101-f are discussed in greater detail, infra, with respect to FIGS. 2, 3, 4, 5, 6, 7, and 8.

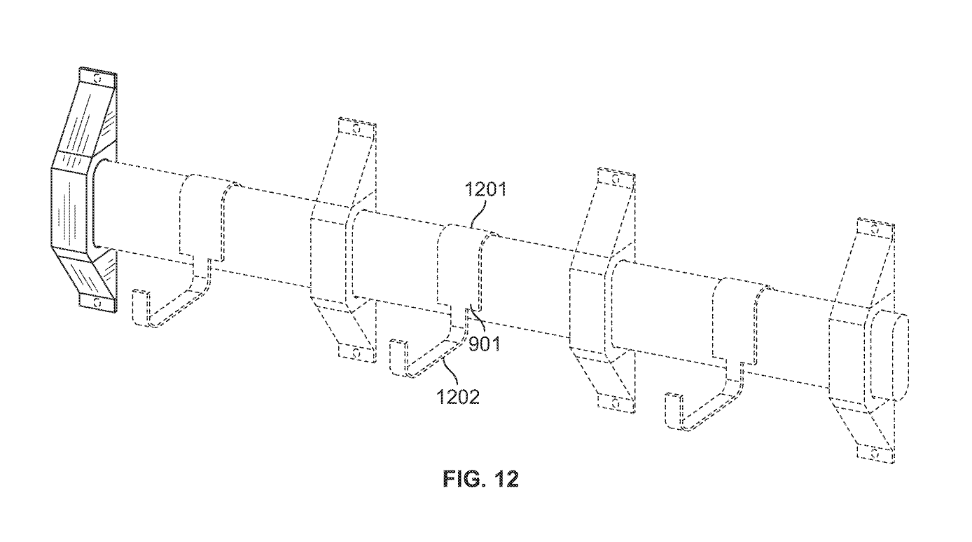

System 100 utilizes the brackets 101-a through 101-f to hold up Rail 102. In turn, accessories are then attached to Rail 102. One example of such an accessory, in accordance with the illustrative embodiment of the present invention, is described, infra, with respect to FIG. 12.

FIG. 2 depicts bracket 101-a in accordance with the illustrative embodiment of the present invention. This depiction on bracket 101-a is that of a view of bracket 101-a from approximately a 45-degree angle from the front. From a front facing view, one viewing would view this bracket from a left angle. Bracket 101-a is comprised of fastening point 201-a, fastening point 201-b, structural support 202-a, structural support 202-b, connection-point support 203-a, connection point 203-b, front face 204, and rail slot 205.

Although, in accordance with the illustrative embodiment of the present invention, bracket 101-a is comprised of plastic, it will be clear to one skilled in the art, after reading this disclosure, how to make and use alternative embodiments of the present invention in which any material is used, for example, and without limitation: metal, a different plastic, resin, wood, a combination alloy, acrylic, glass, polymer, polyester or copolyester, or other high-strength material.

Although, in accordance with the illustrative embodiment of the present invention, bracket 101-a is in a trapezoidal shape, it will be clear to one skilled in the art, after reading this disclosure, how to make and use alternative embodiments of the present invention in which bracket 101-a is in a different shape, for example, and without limitation: rectangular.

Although, in accordance with the illustrative embodiment of the present invention, bracket 101-a has a single screw hole at the top of its shape, attachment point 201-a, it will be clear to one skilled in the art, after reading this disclosure, how to make and use alternative embodiments of the present invention in which there are any number of screw holes and in any position or part of bracket 101-a.

Although, in accordance with the illustrative embodiment of the present invention, bracket 101-a has a single screw hole at the bottom of its shape, attachment point 201-b, it will be clear to one skilled in the art, after reading this disclosure, how to make and use alternative embodiments of the present invention in which there are any number of screw holes and in any position or part of bracket 101-a.

Although, in accordance with the illustrative embodiment of the present invention, bracket 101-a has a single opening in the middle, rail slot 205, it will be clear to one skilled in the art, after reading this disclosure, how to make and use alternative embodiments of the present invention in which there are any number of openings in the middle of bracket 101-a.

Although, in accordance with the illustrative embodiment of the present invention, bracket 101-a has an opening with the shape of an elongated oval or a mostly rectangular shape with rounded ends, it will be clear to one skilled in the art, after reading this disclosure, how to make and use alternative embodiments of the present invention in which the opening takes another shape, for example, and without limitation: totally rectangular, circular, cylindrical, etc.

Although, in accordance with the illustrative embodiment of the present invention, bracket 101-a is attached to a concrete wall of the garage, it will be clear to one skilled in the art, after reading this disclosure, how to make and use alternative embodiments of the present invention in which bracket 101-a is attached to a different point, for example, and without limitation: dry wall, sheet rock, a wall stud, solid wood, a second bracket, etc.

Although, in accordance with the illustrative embodiment of the present invention, bracket 101-a is attached by means of screws, it will be clear to one skilled in the art, after reading this disclosure, how to make and use alternative embodiments of the present invention in which an alternative fastener is used, for example, and without limitation: nails, a proprietary screw system, bolts, glue, hook-and-loop fastener, tape, etc.

Although, in accordance with the illustrative embodiment of the present invention, the view of bracket 101-a depicted is that of a view of bracket 101-a from approximately a 45-degree angle from the front, it will be clear to one skilled in the art, after reading this disclosure, how to make and use alternative embodiments of the present invention in which an alternative view is taken.

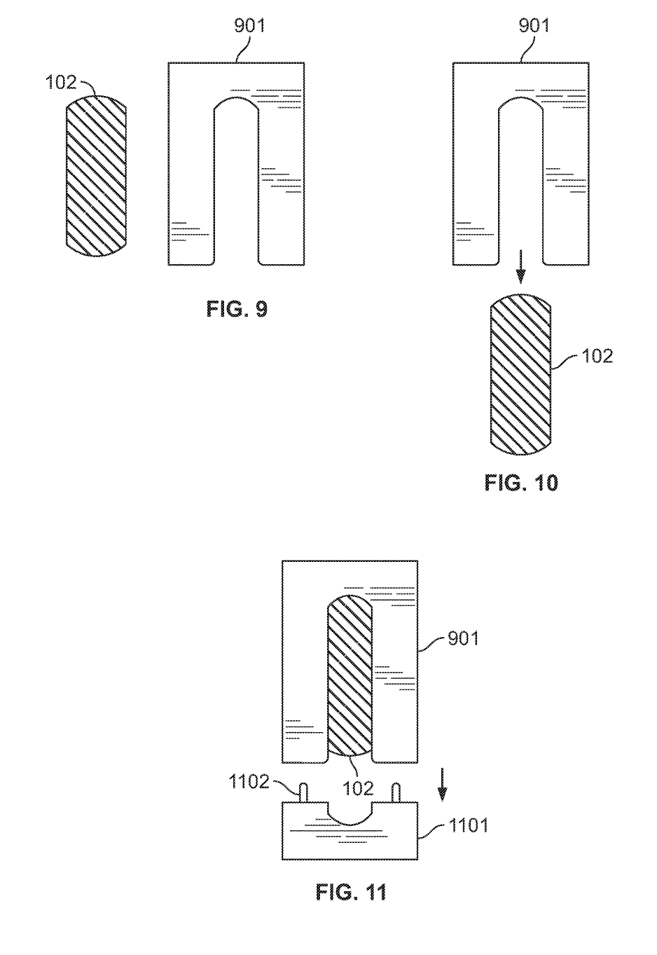

Bracket 101-a is shown as a single piece in which there is—in the illustrative embodiment—at least one other bracket through which rail 102 would be placed so that attachments may be added to system 100 for functionality. With bracket 101-a and a second bracket attached to a wall, rail 102 can then slide in hole 205 and attachments can then be laid upon rail 102. This attachment system is described further, infra, with regard to FIGS. 9 through 12.

Although rail slot 205 is depicted as being in the same shape as rail 102, in with will be clear to one skilled in the art, after reading this disclosure, how to make and use alternative embodiments of the present invention in which another shape is used, for example, and without limitation: a rectangular shape that may allow for space between rail 102 and rail slot 205.

Although rail slot 205 is depicted as being in the same molding as the rest of bracket 101-a, it will be clear to one skilled in the art, after reading this disclosure, how to make and use alternative embodiments of the present invention in which rail slot 205 is comprised of a different material. Further, it will be clear to one skilled in the art, after reading this disclosure, how to make and use alternative embodiments of the present invention in which a ring of another material is placed in rail slot 205 to reinforce rail slot 205 when rail 102 is inserted, e.g. a metal ring inside of rail slot 205.

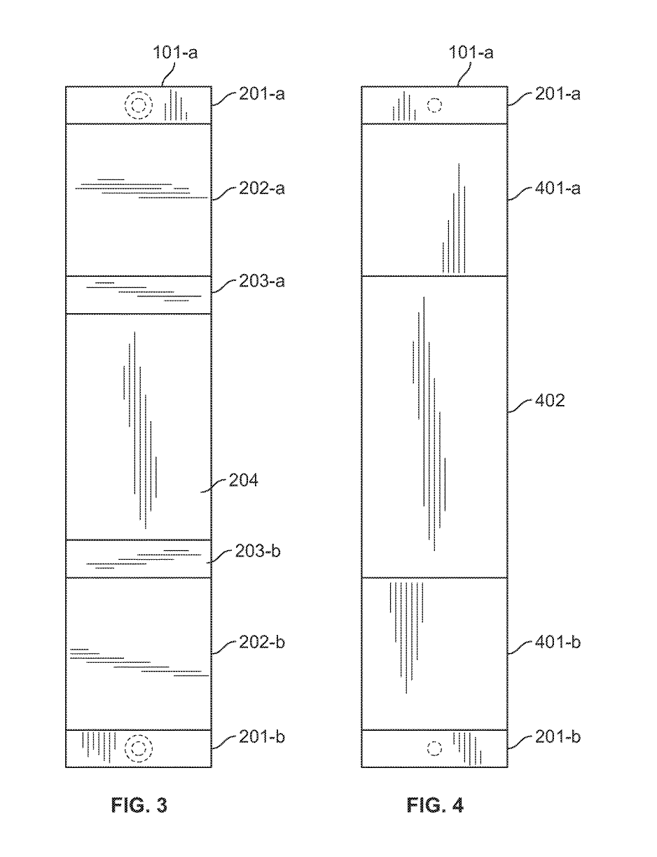

FIG. 3 depicts bracket 101-a in accordance with the illustrative embodiment of the present invention. This depiction is that of a front view of bracket 101-a. Bracket 101-a is comprised of fastening point 201-a, fastening point 201-b, structural support 202-a, structural support 202-b, connection-point support 203-a, connection point 203-b, front face 204, and rail slot 205 (not shown at this angle).

Although, in accordance with the illustrative embodiment of the present invention, the view of bracket 101-a depicted as being is several separate portions in order to illustrate the portions of bracket 101-a. However, it will be clear to one skilled in the art, after reading this disclosure, how to make and use alternative embodiments of the present invention in which the back view of bracket 101-a is a single piece.

Because in accordance with the illustrative embodiment of the present invention, bracket 101-a would be molded as a single piece, the portions shown of bracket 101-a would instead be a single line. The portions shown separately are for illustrative purposes.

Although, bracket 101-a depicted as being is several separate portions in order to illustrate the portions of bracket 101-a. However, it will be clear to one skilled in the art, after reading this disclosure, how to make and use alternative embodiments of the present invention in which the back view of bracket 101-a is a single piece.

FIG. 4 depicts bracket 101-a in accordance with the illustrative embodiment of the present invention. This depiction is that of a back view of bracket 101-a. Bracket 101-a is comprised of fastening point 201-a, fastening point 201-b, rear panel portion 401-a, rear panel portion 401-b, and rear panel portion 402.

Although, in accordance with the illustrative embodiment of the present invention, the view of bracket 101-a depicted as being is several separate portions in order to illustrate the portions of bracket 101-a. However, it will be clear to one skilled in the art, after reading this disclosure, how to make and use alternative embodiments of the present invention in which the back view of bracket 101-a is a single piece.

In accordance with the illustrative embodiment of the present invention, the length of real panel portion 402 is approximately the same length as that of the sum of the lengths of 203-a, 204, and 203-b. However it will be clear to one skilled in the art, after reading this disclosure, how to make and use alternative embodiments of the present invention in which the lengths are different.

In accordance with the illustrative embodiment of the present invention, the length of real panel portion 401-a is approximately the same length as that of structural support 202-a. Also in accordance with the illustrative embodiment of the present invention, the length of real panel portion 401-b is approximately the same length as that of structural support 202-b. However it will be clear to one skilled in the art, after reading this disclosure, how to make and use alternative embodiments of the present invention in which the length of real panel portion 401-a and structural support 202-b are different.

Because in accordance with the illustrative embodiment of the present invention, bracket 101-a would be molded as a single piece, the portions shown of bracket 101-a would instead be a single line. The portions shown separately are for illustrative purposes.

Although, bracket 101-a depicted as being is several separate portions in order to illustrate the portions of bracket 101-a. However, it will be clear to one skilled in the art, after reading this disclosure, how to make and use alternative embodiments of the present invention in which the back view of bracket 101-a is a single piece.

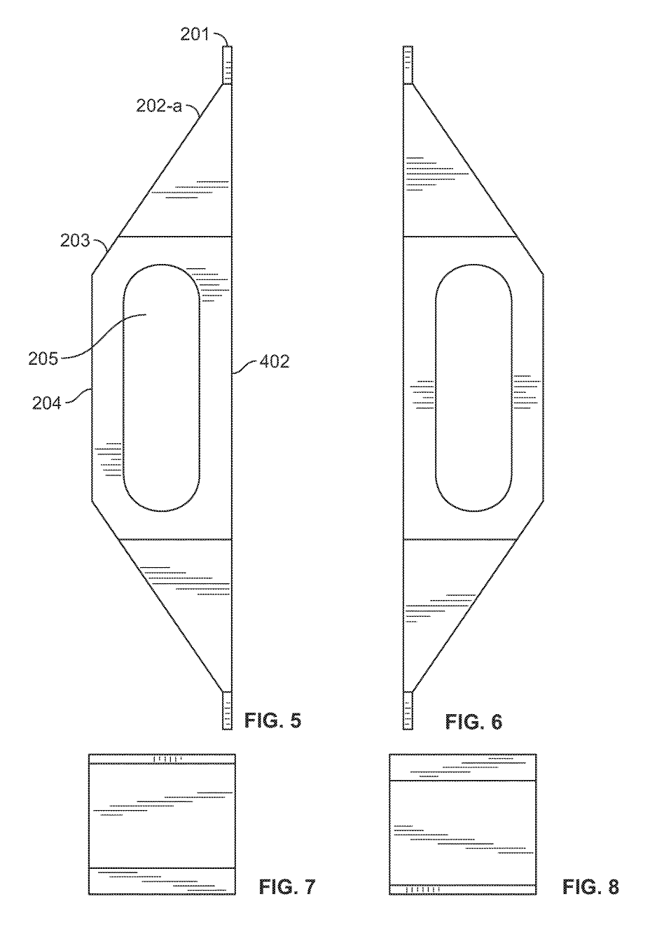

FIG. 5 depicts bracket 101-a in accordance with the illustrative embodiment of the present invention. This depiction is that of a side view of bracket 101-a. From a side facing view, one viewing would view this bracket from a left side. Bracket 101-a is comprised of fastening point 201-a, fastening point 201-b, structural support 202-a, structural support 202-b, connection-point support 203-a, connection point 203-b, front face 204, rail slot 205, rear panel portion 401-a, rear panel portion 401-b, and rear panel portion 402.

In accordance with the illustrative embodiment of the present invention, bracket 101-a depicted as being is several separate portions in order to illustrate the portions of bracket 101-a. However, it will be clear to one skilled in the art, after reading this disclosure, how to make and use alternative embodiments of the present invention in which the back view of bracket 101-a is a single piece.

FIG. 6 depicts bracket 101-a in accordance with the illustrative embodiment of the present invention. This depiction is that of a side view of bracket 101-a. This depiction is that of a side view of bracket 101-a. From a side facing view, one viewing would view this bracket from a right side. Bracket 101-a is comprised of fastening point 201-a, fastening point 201-b, structural support 202-a, structural support 202-b, connection-point support 203-a, connection point 203-b, front face 204, rail slot 205, rear panel portion 401-a, rear panel portion 401-b, and rear panel portion 402.

Bracket 101-a depicted as being is several separate portions in order to illustrate the portions of bracket 101-a. However, it will be clear to one skilled in the art, after reading this disclosure, how to make and use alternative embodiments of the present invention in which the back view of bracket 101-a is a single piece.

FIG. 7 depicts bracket 101-a in accordance with the illustrative embodiment of the present invention. This depiction is that of a top-down view of bracket 101-a.

In accordance with the illustrative embodiment of the present invention, bracket 101-a depicted as being several separate portions in order to illustrate the portions of bracket 101-a. However, it will be clear to one skilled in the art, after reading this disclosure, how to make and use alternative embodiments of the present invention in which the back view of bracket 101-a is a single piece.

FIG. 8 depicts bracket 101-a in accordance with the illustrative embodiment of the present invention. This depiction is that of a bottom-up view of bracket 101-a.

In accordance with the illustrative embodiment of the present invention, bracket 101-a is depicted as being several separate portions in order to illustrate the portions of bracket 101-a. However, it will be clear to one skilled in the art, after reading this disclosure, how to make and use alternative embodiments of the present invention in which the back view of bracket 101-a is a single piece.

FIG. 9 depicts system 100 in accordance with the illustrative embodiment of the present invention. This depiction is that of a side view of system 100. System 100 is comprised of rail 102 and attachment 901.

Although, in accordance with the illustrative embodiment of the present invention, system 100 is depicted as having one (1) rail, it will be clear to one skilled in the art, after reading this disclosure, how to make and use alternative embodiments of the present invention in which there are any number of rails.

Although, in accordance with the illustrative embodiment of the present invention, system 100 is depicted as having one (1) attachment, it will be clear to one skilled in the art, after reading this disclosure, how to make and use alternative embodiments of the present invention in which there are any number of attachments.

Although, in accordance with the illustrative embodiment of the present invention, attachment 901 is depicted as having squared-off corners (i.e. they end at approximately 90-degree angles), it will be clear to one skilled in the art, after reading this disclosure, how to make and use alternative embodiments of the present invention in which there are other corners, for example and without limitation: rounded ends (i.e. no corners), angled corners (e.g. 45-degrees), etc.

Although, in accordance with the illustrative embodiment of the present invention, attachment 901 is depicted as having sides that are of approximately the same length as that of rail 102, it will be clear to one skilled in the art, after reading this disclosure, how to make and use alternative embodiments of the present invention in which the sides of attachment 901 are of a different length.

FIG. 10 depicts system 100 in accordance with the illustrative embodiment of the present invention. This depiction is that of a side view of system 100. System 100 is comprised of rail 102 and attachment 901.

Although, in accordance with the illustrative embodiment of the present invention, system 100 is depicted as having one (1) rail, it will be clear to one skilled in the art, after reading this disclosure, how to make and use alternative embodiments of the present invention in which there are any number of rails.

Although, in accordance with the illustrative embodiment of the present invention, system 100 is depicted as having one (1) attachment, it will be clear to one skilled in the art, after reading this disclosure, how to make and use alternative embodiments of the present invention in which there are any number of attachments.

In accordance with the illustrative embodiment of the present invention, attachment 901 is depicted as being placed upon rail 102. However, it will be clear to one skilled in the art, after reading this disclosure, how to make and use alternative embodiments of the present invention in which another attachment mechanism can be used.

In accordance with the illustrative embodiment of the present invention, attachment 901 stays in place by means of its length, i.e. that its length is approximately that of rail 102 and the longer shape of rail 102 and attachment 901 keeps attachment 901 from sliding off of rail 102. However, it will be clear to one skilled in the art, after reading this disclosure, how to make and use alternative embodiments of the present invention in which alternative methods are used to keep attachment 901 attached to rail 102, for example, and without limitation: the attachment cap described, infra, in FIG. 11, additional slots, snaps, hook and loop, etc.

FIG. 11 depicts system 100 in accordance with the illustrative embodiment of the present invention. This depiction is that of a side view of system 100. System 100 is comprised of rail 102, attachment 901, attachment cap 1101, and peg 1102.

Although, in accordance with the illustrative embodiment of the present invention, system 100 is depicted as having one (1) rail, it will be clear to one skilled in the art, after reading this disclosure, how to make and use alternative embodiments of the present invention in which there are any number of rails.

Although, in accordance with the illustrative embodiment of the present invention, system 100 is depicted as having one (1) attachment, it will be clear to one skilled in the art, after reading this disclosure, how to make and use alternative embodiments of the present invention in which there are any number of attachments.

Although, in accordance with the illustrative embodiment of the present invention, system 100 is depicted as having one (1) attachment cap, it will be clear to one skilled in the art, after reading this disclosure, how to make and use alternative embodiments of the present invention in which there are any number of attachment caps.

Although, in accordance with the illustrative embodiment of the present invention, attachment cap 1101 is depicted as having two (2) pegs, it will be clear to one skilled in the art, after reading this disclosure, how to make and use alternative embodiments of the present invention in which there are any number of pegs.

Although, in accordance with the illustrative embodiment of the present invention, attachment cap 1101 attaches to attachment 901 by means of pegs 1102, it will be clear to one skilled in the art, after reading this disclosure, how to make and use alternative embodiments of the present invention in which another fastening method is used, for example, and without limitation: a peg and socket, a dowel, ball and socket, hook-and-loop fastener, etc.

Further, attachment cap 1101 is an optional add-on to attachment 901 that helps to keep attachment 901 in place. This feature could be especially useful, for example, and without limitation: in instances in which system 100 is attached to an angled wall or to a ceiling, in instances in which it is preferable for attachment 901 to be attached to rail 102 upside-down, etc.

Further, attachment cap 1101 serves to lock attachment 901 in place on rail 102. This allows for additional stability beyond that of the use of attachment 901 alone. However, it will be clear to one skilled in the art, after reading this disclosure, how to make and use alternative embodiments of the present invention in which attachment cap 1101 is omitted in certain applications or omitted entirely.

FIG. 12 is depicts system 100 in accordance with the illustrative embodiment of the present invention.

System 100 is comprised of brackets 101-a through 101-d, rail 102, and attachments 1201-a, 1201-b, and 1201-c.

Although system 100 consists of four (4) brackets, it will be clear to one skilled in the art, after reading this disclosure, how to make and use alternative embodiments of the present invention in which there are any number of brackets.

Although system 100 consists of one (1) rail, it will be clear to one skilled in the art, after reading this disclosure, how to make and use alternative embodiments of the present invention in which there are any number of rails.

Although system 100 consists of three (3) attachments, it will be clear to one skilled in the art, after reading this disclosure, how to make and use alternative embodiments of the present invention in which there are any number of attachments.

Although system 100 consists of only hook attachments, it will be clear to one skilled in the art, after reading this disclosure, how to make and use alternative embodiments of the present invention in which there are different attachments, for example, and without limitation: pegs, shelves, shelving brackets, organization apparatuses, etc. These items could be designed for any number of applications, including but not limited to: automotive (e.g., specialized organizational attachments for tools, cleaners, etc.), sports (e.g., specialized organizational attachments for equipment, sporting goods, balls, etc.), children (specialized organizational attachments for toys, skateboards, scooters, etc.), etc.

Although system 100 is depicted of being on the wall of a room, specifically that of a garage, it will be clear to one skilled in the art, after reading this disclosure, how to make and use alternative embodiments of the present invention in which system 100 is placed in any other room, a closet, etc. Other applications may include shelving in a retail store, hanging items from a ceiling (e.g., planters, lighting, etc.), or any application in which affixing items to a solid platform, ceiling, wall, etc. may be advantageous.

Brackets 101-a through 101-f are discussed in greater detail, supra, with respect to FIGS. 2, 3, 4, 5, 6, 7, and 8.

Rail 102 is discussed in greater detail, supra, with respect to FIG. 1.

Attachments 1201-a through 1201-d are hooks that allow for a user to hang items on rail 102 and system 100. For example, and without limitation, in a garage hanging, items may include: shovels, tools, carts, sports equipment, etc.

In accordance with the illustrative embodiment of the present invention, attachment 1201-a through 1201-d are molded out of a single piece of plastic, however it will be clear to one skilled in the art, after reading this disclosure, how to make and use alternative embodiments of the present invention in which are molded out of a different material, for example, and without limitation: multiple pieces of plastic, a combination of plastic and other components, resin, etc.

Further in accordance with the illustrative embodiment of the present invention, attachments 1201-a through 1201-d are shaped with the portion that rests upon rail 102 to be molded in a shape like that of attachment 901, as discussed, infra, with respect to FIGS. 9, 10, and 11.

Hook 1201-a, et. seq. would be molded as a single piece, in that the hook portion and the portion that rests upon rail 102 (901) would be one mold.

It will be clear to one skilled in the art, after reading this disclosure, how to make and use other implementations of the present invention in which one or more of the parts are omitted or are utilized in a different manner than the one presented.

It is to be understood that the disclosure teaches just one example of the illustrative embodiment and that many variations of the invention can easily be devised by those skilled in the art after reading this disclosure and that the scope of the present invention is to be determined by the following claims.

1. An apparatus comprising:
a rail; and
a first bracket;
wherein the rail is shaped in an elongated-oval shape,
wherein the bracket has a slot matching the shape of the rail, and
wherein the rail extends through the bracket.

2. The apparatus of claim 1 further wherein the bracket is trapezoidal in shape

3. The apparatus in claim 1 further wherein the rail is comprised of a resin.

4. The apparatus of claim 3 further wherein the resin in a high-strength material.

5. The apparatus of claim 1 further wherein the rail is formed in a single molding.

6. The apparatus of claim 1 further wherein the first bracket is formed in a single molding.

7. The apparatus of claim 1 further comprising a first attachment.

8. The apparatus of claim 7 further wherein first attachment attaches to the rail.

9. The apparatus of claim 8 further comprising a first cap on the first attachment.

10. The apparatus of claim 9 further wherein the first cap attaches to the first attachment by means of a peg.

11. The apparatus of claim 7 in which the first attachment is a hook.

12. The apparatus of claim 7 in which the first attachment is a first shelving bracket.

13. The apparatus of claim 7 further comprising:
a second attachment,
and wherein the second attachment is comprised of the same material as the first attachment.

14. A system comprising:
a rail; and
a first bracket;
wherein the rail is shaped in an elongated-oval shape,
wherein the bracket has a slot matching the shape of the rail, and
wherein the rail extends through the bracket.

15. The system of claim 14 further comprising:
a second bracket;
a first attachment;
a second attachment;
wherein the first attachment and the second attachment connect by means of the rail and by means of a shelf.

16. An apparatus comprising:
a rail; and
a first attachment;
wherein the rail and the first attachment are comprised of the same material,
wherein the rail is shaped in an elongated-oval shape, and
wherein the rail extends through the bracket.

17. The apparatus of claim 16 wherein the material that comprises the rail and the first attachment is a high-strength resin.

18. The apparatus of claim 16 wherein the material that comprises the rail and the first attachment is plastic.

19. The apparatus of claim 16 wherein the material that comprises the rail and the first attachment is polymer.

20. The apparatus of claim 16 wherein the material that comprises the rail and the first attachment is copolymer.
